(19) United States
(12) Patent Application Publication
(10) Pub. No.: US 2022/0164909 A1
(43) Pub. Date: May 26, 2022

(54) Frictionless Patron Monitoring

(71) Applicant: NCR Corporation, Atlanta, GA (US)

(72) Inventors: Christian McDaniel, Atlanta, GA (US); Brent Vance Zucker, Roswell, GA (US)

(21) Appl. No.: 17/104,969

(22) Filed: Nov. 25, 2020

(51) Int. Cl. G06Q 50/26; G06Q 30/00; G06Q 10/06; G07C 9/00; G06Q 50/12; G06Q 10/02; G06Q 20/32; G06Q 20/40; G06Q 30/06; G06K 9/00

(52) U.S. Cl. CPC G06Q 50/265; G06Q 30/0185; G06Q 10/06315; G06Q 10/06311; G07C 9/00; G06Q 50/12; G10L 17/22; G06Q 20/3224; G06Q 20/40145; G06Q 30/0635; G06K 9/00335; G06K 9/00711; G06Q 10/02

(57) ABSTRACT

An identity of a patron within an establishment is authenticated when the patron enters the establishment using a variety of attributes captured in a real-time video. The identity is mapped to a registered profile of the patron that comprises at least a registered payment method. The patron is tracked to locations within the establishment as the patron moves around the establishment. Actions, behaviors, and gestures of the patron are mapped to service requests from the video. Staff are dispatched to prepare services items for the service requests and to assist the patron at current patron location within the establishment. The staff and the service items are also monitored from the video. Furthermore, the staff and the patron are monitored in the video for prohibited behaviors and actions. When the patron leaves the establishment, payment for the service items is automatically processed using the registered payment method of the registered profile.

### BACKGROUND

The COVID19 pandemic has had a tremendous negative impact on customer experiences, such as dining at restaurants, gambling at casinos, drinking at bars, watching sports at stadiums, listening to entertainers at concerts, relaxing on cruise ships, and other experiences. Much of these activities are now banned during the pandemic by local governments.

Customers are eager to safely engage in their previous activities and being unable to do so has created a host of other mental health issues throughout society. Governments are reluctant to reopen establishments for fear of overwhelming health resources. Customers are also anxious about potentially contracting the virus while engaging in pre-pandemic activities. They want assurances that staff and customers are engaging in social distancing, wearing masks when appropriate, and that touch surfaces are regularly sanitized and not contaminated by potentially infected individuals.

As a result, businesses are trying to institute safety procedures and practices in order to assuage governments and their customers that it is safe for customers to come back to the businesses and engage in their pre-pandemic activities. During this exercise toward improved safety, the goal of businesses is to minimize interactions between customers and minimize interactions between customers with the staff while also ensuring that the staff is not idle and being efficiently utilized, and ensuring that the customers are not waiting too long for service and not congregating in crowds within certain locations of the businesses.

One type of customer interaction, which businesses have attempted to address, is customer payments. In fact, some businesses no longer accept cash as a form of payment, and some businesses have endeavored to perform payments entirely without the customers being required to touch anything other than their own mobile devices.

However, there remains many customer interactions/situations that have not been addressed adequately from a health and safety standpoint, such as restricting the amount of available surfaces that customers and staff are continuously touching and reducing areas where customers and/or staff must congregate to obtain or to provide service (e.g., at a kiosk, at a Point-Of-Sale (POS) terminal operated by staff for taking orders/requests, at a bar, at an Automated Teller Machine (ATM), at a casino cash cage or Self-Service (SS) ticket cash out terminal, etc.).

Another problem area is associated with monitoring of customers to ensure that customers are in fact engaging in the government-mandated health precautions, such as mask wearing, social distancing, etc. Businesses are not staffed and trained adequately to enforce health guidelines on their customers. Yet, many governments have mandated that businesses enforce the health guidelines or be subject to fines and/or closures during the pandemic.

Attempts at health-guideline enforcement by staff may be met by customer denials and lead to confrontations between staff and customers. Furthermore, overzealous customers may engage in policing other customers during the pandemic for health guidelines, which more often than not results in confrontations between customers, such confrontations end up being filmed and posted on social media, some even make the local or national news. All of these attempted enforcement scenarios create unwanted and negative publicity for the businesses, at a time when businesses are struggling to stay open, attract customers to their businesses, and build a loyal customer base.

### SUMMARY

In various embodiments, methods and a system for frictionless patron monitoring are presented.

According to an embodiment, a method for frictionless patron monitoring is presented. A patron is identified within an establishment from a video. The patron is authenticated to an identity that is linked to a payment method and the patron is tracked to a location within the establishment from the video. A service request is generated for the patron based on at least one action, behavior, or gesture detected from the patron in the video and a service item being prepared for the service request is monitored from the video. A staff member is dispatched to deliver the service item to the patron at the location when the monitoring indicates the service item is ready for pickup by the service staff member. A payment for the service item is processed using the payment method when the patron exits the establishment.

### BRIEF DESCRIPTION OF THE DRAWINGS

FIG. is a diagram of a system for frictionless patron monitoring, according to an example embodiment.

FIG. 2 is a diagram of a method for frictionless patron monitoring, according to an example embodiment.

FIG. 3 is a diagram of another method for frictionless patron monitoring, according to an example embodiment.

### DETAILED DESCRIPTION

FIG. 1 is a diagram of a system 100 for frictionless patron monitoring according to an example embodiment. It is to be noted that the components are shown schematically in greatly simplified form, with only those components relevant to understanding of the embodiments being illustrated.

Furthermore, the various components (that are identified in the FIG. 1) are illustrated and the arrangement of the components is presented for purposes of illustration only. It is to be noted that other arrangements with more or less components are possible without departing from the teachings of frictionless patron monitoring, presented herein and below.

System 100 provides mechanism by which a customer entering an establishment can monitored for purposes of providing personalized service to the customer, checking the customer out of the establishment, and ensuring the customer is not engaging in prohibited behaviors during a frictionless experience with the establishment, A virtual identity is assigned to the customer upon entry into the establishment and tracked to locations within the establishment, Once sufficient information is ascertained for the customer, the virtual identity is authenticated to a true identity of the customer. The true identity is linked to a registered profile for the customer, which minimally includes a registered payment card or a registered payment service of the customer. Behaviors, actions, and gestures of the customer are monitored using the video while the customer remains within the establishment. Any staff member of the enterprise that interacts with the customer is also monitored from the video, Predefined behaviors, actions, and gestures are mapped to service requests, which are being directly or indirectly communicated by the customer, Appropriate staff actions are ordered and/or dispatched to the customer location within the establishment in order to satisfy the requests for the customer. Confirmations of customer requests may be automatically communicated to the customer via registered customer-operated devices, digital signs adjacent to the customer, or through speakers adjacent to the customer using auto-generated natural language speech. A customer is also monitored while within the establishment for prohibited behaviors based on predefined behavior controls. Violations of prohibited behaviors may illicit warnings communicated to the customer via the user device, digital sign, and/or speaker. A repeated violation or a sever violation may cause a staff member to escort the customer out of the establishment or automatically dispatch authorities to the establishment to address the violation on behalf of the establishment.

System 100 is frictionless, which means minimal, and in some cases, no physical interaction between the customer and staff of the establishment. A customer can check-in without touching or engaging a touch service of a terminal, without congregating in front of a check-in terminal with other customers. The customer can select, be assigned, or chose a location to go within the establishment and engage in non-touch behaviors, actions, or gestures to place service orders of the staff. The service items are ordered for the customer, tracked to completion, and delivered directly to the customer location or to a communicated pickup area for customer self-pickup at a designated time. A customer can change, modify, or cancel service items associated with their service order through the behaviors, actions, and/or gestures without performing any touch interactions on any establishment terminal surfaces and without directly physically interacting with staff that needs to be present at the customer location within the establishment. When the customer is ready to leave, the customer simply leaves the establishment and payment for the services are processed using the customer's registered payment card or payment service within their profile. A receipt for the transaction/service order may be electronically mailed or sent to the customer for the customer's record.

System 100 also simultaneously directs staff via staff devices, digital signs, and/or terminals to prepare the service items for a specific customer associated with the service items. Images of the customer, a name of the customer, and the location of the customer within the establishment is tracked with each ordered service item and available to the staff on the staff devices, digital signs, and/or terminals. Problematic customer behavior is also reported to the staff along with a video clip of the problematic behavior.

As used herein and below, the terms “customer,” “user,” “consumer,” “individual,” “subject,” and “patron” may be used interchangeably and synonymously. The terms refer to a guest that is being monitored within a monitored area of an establishment. The monitored area may be indoors, outdoors, or a combination of both indoors and outdoors.

An “object” refers to an asset and/or a structure located within the establishment. The object may include drawers, countertops, benches, computers, keys, cash, checks, tables, security panels, chairs, windows, notary stamps, doors, documents, terminals, shelving, money, safes, dishes, cookware, utensils, condiments, refrigerators, stoves, ovens, cabinets, liquor bottles/cans/dispensers, soda bottles/cans/dispensers, water bottles/cans/dispensers, service items being sold within the establishment, etc. The objects are being monitored within the image frames of one or more videos provided in video feeds.

A “biometric feature,” or a “biometric attribute” may be used interchangeably and synonymously herein and refers to sensor captured data, audio derived characteristics from audio, and/or image derived characteristics from images, which uniquely exhibits a characteristic of an individual. In some cases, a single biometric attribute may be sufficient to uniquely identify an individual. In some cases, multiple biometric attributes are used to unique identify an individual.

System 100 includes a plurality of cameras 110 that capture time-stamped videos 111 of persons and objects outside and on a premise of an establishment and within the establishment. System 100 includes user devices/staff devices/terminals 140 used to process service orders and transactions associated with the establishment and process payments with one or more external systems 150 (external payment systems 150) that are external and remote to an establishment's systems. System 100 also includes sensors, speakers, microphones, and/or digital signs 130 dispersed throughout the establishment and/or integrated into other devices, such as terminals 140.

Moreover, system 100 also includes server 120. Server 120 includes executable instructions that execute on one or more hardware processors 121 of server 120 from a non-transitory computer-readable storage medium 122 as: attribute aggregator 123, person tracker 124, object tracker 125, behavior-action tracker 126, gesture tracker 127, authenticator 128, and transaction/service manager 129A.

Non-transitory computer-readable-storage medium 122 of server 120 also includes: customer profiles 129B and behavior controls 129C.

Behavior controls 129C represents a data structure comprising and embodying business rules associated with predefined business policies required by an establishment of customers and staff while within the monitored area of the establishment. The data structure includes statements of area identifiers for locations within the establishment, asset/object identifiers for objects, action identifiers, behavior identifiers, service order numbers or transaction numbers, task resolution identifiers for tasks, and conditions that defines rules. Each rule identifying a prohibited behavior or action that is prohibited by the establishment along with one or more tasks that are to be performed in response to that prohibited behavior or action. Tasks can be automatically processed when conditions are met with an external system 150, such as emergency systems or tasks can be activities required by staff to perform when conditions are met. The sequence of the tasks may also be defined within the conditions for the rules, such that multiple tasks are to be performed when a rule is violated. Each task may also include a staff identifier associated with a specific staff member that is to perform the tasks when a given rule is violated. Each task may also include resource identifier associated with the an automated application, external system 150, an internal establishment system, or an electronic contact address of an individual that is to receive an automated message when the conditions are met for a given rule.

A given “task” may also be referred to as a set of predefined activities or activities.

It is to be noted that there may be multiple servers 120, such that the different elements 123-129A-C may execute on a same server 120 or multiple different servers 120 networked together within a cloud processing environment.

Cameras 110 are preconfigured to capture videos 111 of areas that are inside and outside the establishment based on the field-of-view of the lenses of cameras 110. Some of cameras 110 may capture video 111 representing portions of a different area than a different one of the cameras 110 captures video 111 for. That is, each video 111 can include frames that may overlap multiple ones of the defined areas covered in the field-of-view of a different camera 110, Some area identifiers may be associated with zones that are subject to enhanced security policies.

In an embodiment, the cameras 110 can be situated at different angles and heights within the areas where they are located. Additionally, there may be one or more overhead cameras 110 both inside and outside the establishment. Some cameras 110 may be specifically calibrated to capture eyes and faces of the individuals. Some cameras 110 may be of higher quality or of a different type than other cameras 110.

Initially, cameras 110 are situated in locations throughout the establishment and some of the one or more cameras 110 may situated on the outside of the establishment to capture the egress and ingress point of the establishment and optionally to capture a parking lot associated with the establishment and/or outdoor areas associated with customer areas (such as an amusement park, outdoor dining, outdoor concert area, stadium area, etc.). Each camera lens configured to cover one or more predefined areas both inside and outside the establishment.

Furthermore, metadata is assigned to each camera 110 to include a unique camera identifier, a location identifier (representing the physical location that camera 110 is situated), and one or more area identifiers (representing the predefined areas that the lens and field-of-view of camera 110 captures in the video 111).

User devices/staff devices//terminals 140 comprise processing devices that are operated by staff/employees and/or customers of the establishment during transactions, when performing services on behalf of the customers within the establishment, and/or when obtaining information or providing information relevant to any of the transactions. Transactions may comprise service actions and/or processing that are initiated by the customers and/or staff in performance of a portion of a given transaction associated with the establishment. Devices 140 may also include user/staff-operated mobile devices, such as phones, tablets, and/or wearable processing devices. In an embodiment, terminals 140 include Self-Service Terminals (SSTs), Automated Teller Machines (ATMs), teller-operated Point-of-Sale (POS) terminals, mobile phones, tablets, and/or wearable processing devices.

Terminals/use devices 140 include processors and non-transitory computer-readable storage media having executable instructions associated with transaction agents. These transaction agents interact with transaction/service manager 129A during transaction processing and may provide a variety of transaction details to transaction/service manager 129A regarding a current in-progress or initiated transaction.

A “transaction” as used herein may be used synonymously with the phrase “service order.”

Person tracker 124 analyzes pixels in video frames of video feeds 111 and uses a bounding box or region of interest within the pixels to track locations of the individuals and extremities (arms, hands) of the individuals within a known area (specific location) of the establishment based on the area identifiers associated with cameras 110.

Object tracker 125 monitors the structures and assets within the establishment via bounding boxes or regions of interest within pixels of the image frames for the video feeds 111.

Behavior-action tracker 127 utilizes the bounding boxes associated with each individual and, optionally, the objects in possession of that individual to perform more detailed pixel analysis on facial features of the individuals and identify behaviors assigned to specific behavior identifiers. Moreover, location information within the pixels for the bounding boxes of the individuals and any related objects are used by behavior-action tracker 127 to identify actions that corresponding to action identifiers.

Metadata associated with frames of the video 111 permit transaction/service manager 129A to identify locations within an establishment of each person/individual provided by person tracker 124 and each object provided by object tracker 125. Locations within the establishment associated with specific locations are identified as are object identifiers that correspond to assets or structures.

Attribute aggregator 123 provides specific pixel features of specific areas within a bounding box for a person that is identified by person tracker 124, the specific pixel features associated with tracked features of customers and staff members of the establishment. Furthermore, aggregator 123 evaluates behaviors in greater detail as provided and identified by behavior-action tracker 126 for tracked features associated with behaviors. Moreover, aggregator 123 evaluates any sensor data provided by sensors 130. The sensor data can include, by way of example only, facial scans, retina scans, fingerprint scans, digit length scans, palm vein scans, audio samples, voice prints, and others. The behavior features may include gait of an individual, length of a gait, facial expressions, and the like.

Aggregator 123 assembles each feature detectable for a given individual starting as soon as an individual is detected by person tracker 124 within the establishment. Moreover, aggregator 123 continues to gather features as they are discovered for the individual. A person tracker identifier provided by person tracker and the features are provided by aggregator 123 to authenticator 128. As more features are discovered by aggregator 123, they are immediately provided to authenticator 128. Authenticator 128 maintains the person tracker identifier (assigned virtual identity for a given tracked person) and the features and generates a current score for the features, which is then compared against known scores assigned to known customers and their identities. When a given score is within a predefined threshold of confidence, a customer identity match is made. The customer identity is assigned to the person tracker identifier (virtual identity) by authenticator 128 and passed to transaction/service manager 129A.

Transaction/service manager 129A uses the customer identity to access customer profiles 129B and obtain a loyalty account associated with the customer, preferences of the customer, and a registered payment card or payment service for payment of a transaction with the customer at the establishment. Transaction/service manager 129A also receives action and behavior identifiers for detected actions for the person tracker identifier from behavior-action tracker 126 along with object identifiers from object tracker 125. Additionally, any staff member detected in the video 111 is identified in a similar manner as the customer was identified and such staff identities are retained by Transaction/service manager 129A.

Gesture tracker 127 monitors limbs, facial features, and extremities of the tracked customer assigned to the customer identity for predefined gestures indicating that the customer is requesting a service or is ordering a service item. Each predefined gesture assigned a gesture identifier and mapped to some requested service action. For example, a gesture with a hand raised indicates the customer needs something from the staff. A gesture of holding an empty drink up indicates the customer has requested a refill, A gesture with a hand hoover above a table is assigned to a request that the customer wants a waiter to come to the table (note the customer does not have to touch the table nor operate the customer's phone to request this in person waiter request, it is achieved via a gesture without touching any surface).

When a customer enters the monitored area of the establishment, attribute aggregator 123 begins attempting to use authenticator 128 to authenticate the customer to a registered account while person tracker 124 tracks where the customer is moving and sits within the establishment. Once the customer is authenticated to a customer identity and linked to a corresponding profile 129B. Transaction/service manager 129A may send a message to an app on user-operated device 140 welcoming the customer and providing a menu for ordering to the customer. The customer can then order via their user device 140 from the menu of the establishment. Alternatively, a microphone and speaker 130 situated at the location where the customer sat down, uses auto-generated speech to welcome the customer and instruct the customer that the customer can order via voice from the location and/or have menu items spoken to the customer or detailed information about specific menu items spoken to the customer.

Once the order is received, transaction/service manager 129A sends the order details to staff devices or terminals 140 instructing them of the name of the customer, table location of the customer, number of members in the party of the customer, an image of the customer is provided, and the order details. A service staff member is assigned to the customer, and kitchen or beverage staff begin preparing the order details for the customer. The customer may use any gesture to get the assigned service staff to come to the table for an in-person conversation.

As the ordered items are prepared by the kitchen or beverage staff, the ordered items are tracked as objects via object identifiers assigned to a given transaction and customer at a given table. When the ordered items are placed in a service staff pickup area, transaction/service manager 129A sends a notice to the assigned service staff member's device 140 indicating ordered items are ready for pickup and delivery to the customer at the table location. This minimizes interaction between kitchen and beverage staff members and the service staff members and promotes less interaction between the employees, which is compliant with pandemic health guidelines.

In an embodiment, when ordered items are ready, the customer is provided instructions on a pickup location within the establishment to go a self pickup the items. This can be sent by transaction/service manager 129A to an app on user device 140 or communicated through auto-generated speech on a speaker 130 adjacent to the table location of the customer.

While the ordered items for the customer service order/transaction is monitored, the staff is monitored, and the customer is monitored for additional service requests, transaction/service manager 129A utilizes behavior-action tracker 126 for violations of behavioral rules by the customer and/or the staff using behavior controls 129C. Any violation causes the corresponding tasks to be processed or dispatched for processing by specific staff members as discussed above. For example, a customer may order alcohol and may provide the alcohol to a minor at the customer's table or a different table. The task for this rule violation may be for a designated staff member to take the alcohol away from the minor, inform the ordering customer that he can no longer order alcohol, and/or instruct the designated staff member to obtain identification from the minor to validate that the minor is over 21 years of age. A variety of other prohibited behaviors may be automatically monitored ranging from health mandated safety procedures being violated by the staff or the customer to medical emergencies or potentially violent and/or criminal conduct (which may cause an automatic task to be processed to dispatch an emergency services via external system 150. As another example, the establishment may not permit alcohol to be brought in from outside the establishment and the customer may be detected drinking alcohol taken from a bag or pocket of the customer. Further, a customer may be detected smoking, or a total number of alcoholic drinks may exceed what is permissible with the customer observed drinking drinks ordered by other members of the customer's party to avoid the acceptable limit. Furthermore, behavior controls 129C may be used to ensure that customers or staff do not enter unauthorized zones within the establishment, commit theft, violate food safety regulations, etc.

In an embodiment, attribute aggregator 123 is configured to estimate an age of the customer and report the estimated age to transaction/service manager 129A. Any estimated age under 30 may prohibit any ordering of alcohol or accepting of alcohol from a customer verified to be over 21 who ordered alcohol.

In an embodiment, age verification for ordering alcohol can be achieved without a staff member being physically present at the customer table by the customer displaying an identification card from which a camera 110 captures an image along with the face of the customer and automated analysis or remote staff validation is performed for age verification.

When the customer is ready to leave, the customer simply leaves the establishment and transaction/service manager 129A detects through interaction with person tracker 124 that the customer has left. Transaction/service manager 129A obtains from the customer profile 129B the payment card or service and submits the transaction details and total price with the card details or with the payment service to an external payment system 150 for processing payment. A transaction receipt is then sent electronically to an email address of the customer or as a text message to user device 140 using contact information for the customer in profile 129B.

System 100 separately monitors each customer within the establishment. Only one of the customers in a given party have to be authenticated to a customer identity and corresponding customer profile 129. So, groups of customers can be monitored together as one party and each individual member of the party also monitored.

In an embodiment, an app on a customer device 140 automatically identifies the customer upon detecting that its location is within the monitored area. This is reported to transaction/service manager 129A and used to assign the customer identity for the customer but aggregator 123 may still independently use authenticator 128 to confirm the customer identity.

In an embodiment, an app on customer device 140 presents a bar code that identifies the customer, which the customer can present to any camera proximate to or adjacent to a table that the customer sits down at within the establishment. This causes transaction/service manager 129A to assign the customer identity and obtain the profile 129B of the customer. Again, in some cases, aggregator 123 may sill independently use authenticator 128 to confirm the customer identity.

In an embodiment, transaction/service manager 129A maintains food preparation metrics for the kitchen and beverage staff and service staff response time metrics for the service staff for all transactions (service items and orders) within the establishment.

In an embodiment, the customer is free to move about the establishment during the time that the customer is within the establishment, each time the customer moves to a new location, transaction/service manager 129A associates any pending service request with the customer's current location and makes this available to the service staff when the service staff is notified that the service items associated with the service requests are ready to be delivered to the customer. This is particularly useful in a bar setting (amusement park setting or concert venue setting) where patrons move freely from location to location. The service requests and service items are always linked to a current location of the customer within the establishment for the service staff to efficiently deliver the service items to the customer.

In an embodiment, system 100 is deployed as a frictionless customer interaction system within a restaurant, a casino, a stadium, an amusement park, a cruise ship, a bar, or a concert venue.

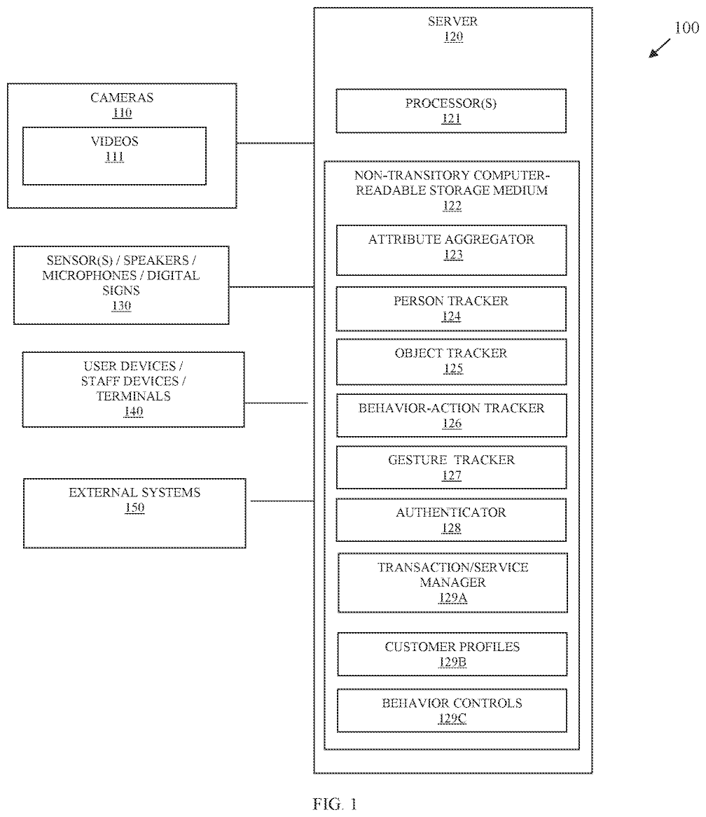

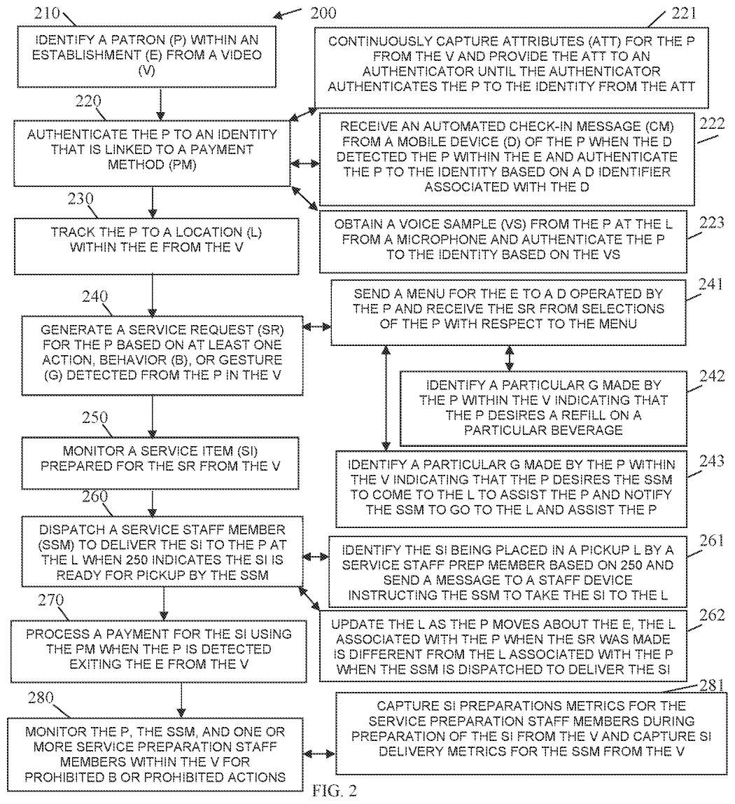

The above-noted embodiments and other embodiments are now discussed with reference to FIGS. 2-4.

FIG. 2 is a diagram of a method 200 for frictionless patron monitoring, according to an example embodiment. The software module(s) that implements the method 200 is referred to as a “frictionless monitor.” The frictionless monitor is implemented as executable instructions programmed and residing within memory and/or a non-transitory computer-readable (processor-readable) storage medium and executed by one or more processors of a device. The processor(s) of the device that executes the frictionless monitor are specifically configured and programmed to process the frictionless monitor. The frictionless monitor may have access to one or more network connections during its processing. The network connections can be wired, wireless, or a combination of wired and wireless.

In an embodiment, the device that executes the frictionless monitor is server 120. In an embodiment, server 120 is a cloud-based server, a local-area network (LAN)-based server, or a wide-area network (WAN) server.

In an embodiment, the frictionless monitor is all or some combination of 123-129A.

At 210, the frictionless monitor identifies a patron within an establishment from a video feed.

At 220, the frictionless monitor authenticates the patron to a patron identity that is linked to a payment method registered for the patron.

In an embodiment, at 221, the frictionless monitor continuously captures attributes for the patron from the video feed or from video feeds. The frictionless monitor continuously provides the attributes to an authenticator until the authenticator authenticates the patron to the patron identity from the attributes.

In an embodiment, at 222, the frictionless monitor receives an automated check-in message from a mobile device of the patron when the mobile device detected the patron within the establishment. The frictionless monitor authenticates the patron to the patron identity based on the mobile device identifier associated with the mobile device.

In an embodiment, at 223, the frictionless monitor obtains a voice sample from the patron at the location from a microphone and authenticates the patron to the identity based on the voice sample.

At 230, the frictionless monitor tracks the patron to a location within the establishment from the video feeds.

At 240, the frictionless monitor generates a service request from the patron based on at least one action, behavior, or gesture detected from the patron in the video feeds.

In an embodiment, at 241, the frictionless monitor sends a menu for the establishment to a mobile device operated by the patron and receives the service request from selections of the patron with respect to the menu.

In an embodiment of 241 and at 242, the frictionless monitor identifies a particular gesture made by the patron within the video feeds indicating that the patron desires a refill on a particular beverage.

In an embodiment of 241 and at 243, the frictionless monitor identifies a particular gesture made by the patron within the video feeds indicating that the patron desires the service staff member to come to the location to assist the patron. The frictionless monitor notifies the service staff member to go to the location and assist the patron.

At 250, the frictionless monitor monitors a service item prepared for the service request from the video feeds.

At 260, the frictionless monitor dispatches a service staff member to deliver the service item to the patron at the location when 250 indicates that the service item is ready for pickup by the service staff member.

In an embodiment, at 261, the frictionless monitor identifies the service item being placed in a service completion or preparation pickup location by a service staff preparation member based on 250 and the frictionless monitor sends a message to a service staff member device of the service staff member instructing the service staff member to take the service item from the pickup location to the patron at the location of the patron within the establishment.

In an embodiment, at 262, the frictionless monitor updates the location of the patron within the establishment as the patron moves about the establishment. The location associated with the patron when the service request was originally made by the patron is different from the location associated with the patron when the service staff member is dispatched to deliver the service item to the patron.

At 270, the frictionless monitor processes a payment for the service item using the payment method when the patron is detected exiting the establishment from the video feeds.

In an embodiment, at 280, the frictionless monitor monitors the patron, the service staff member, and one or more service preparation staff members within the video feeds for prohibited behaviors or prohibited actions.

In an embodiment of 280 and at 281, the frictionless monitor captures service item preparation metrics for the service preparation staff members during preparation of the service item and the frictionless monitor captures service item delivery metrics for the service staff member from the video feeds.

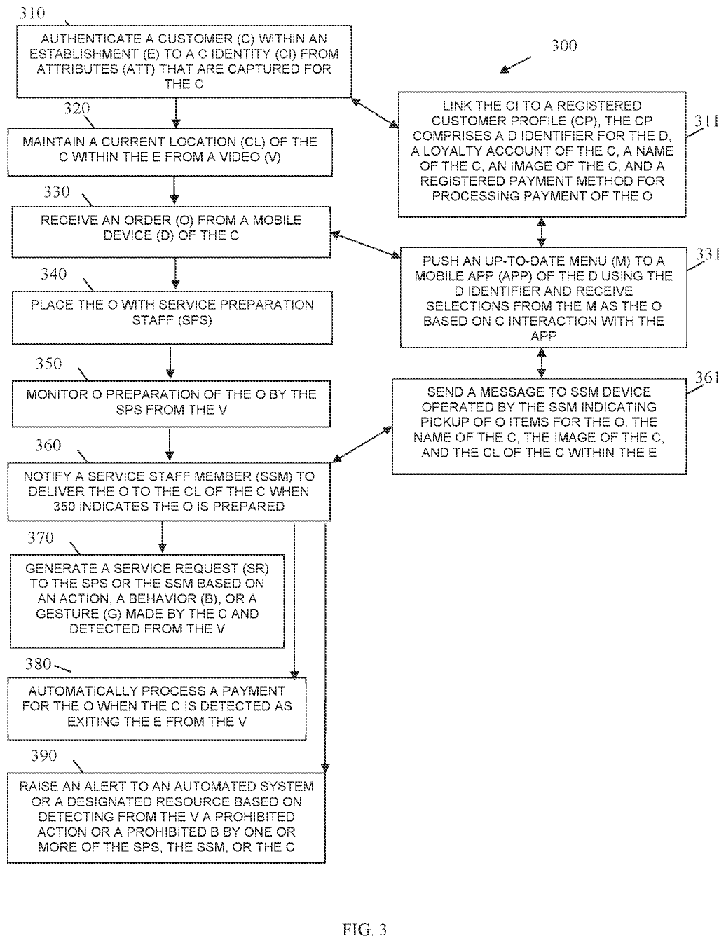

FIG. 3 is a diagram of another method 300 for frictionless patron monitoring, according to an example embodiment. The software module(s) that implements the method 300 is referred to as a “frictionless establishment monitor.” The frictionless establishment monitor is implemented as executable instructions programmed and residing within memory and/or a non-transitory computer-readable (processor-readable) storage medium and executed by one or more processors of a device. The processors that execute the frictionless establishment monitor are specifically configured and programmed to process the frictionless establishment monitor. The frictionless establishment monitor may have access to one or more network connections during its processing. The network connections can be wired, wireless, or a combination of wired and wireless.

In an embodiment, the device that executes the frictionless establishment monitor is the server 120, In an embodiment, the server 120 is a cloud processing environment, a LAN server, or a WAN server.

In an embodiment, the frictionless establishment monitor is all of or some combination of 123-129A and/or the method 200.

The frictionless establishment monitor presents another and, in some ways, enhanced processing perspective of the method 200 discussed above.

At 310, the frictionless establishment monitor authenticates a customer within an establishment to a customer identity from attributes that are captured for the customer.

In an embodiment, at 311, the frictionless establishment monitor links the customer identity to a registered customer profile. The profile comprises a mobile device identifier for a mobile device of the customer, a loyalty account of the customer, a name of the customer, an image of the customer, and a registered payment method for processing payments of the customer for orders placed by the customer.

At 320, the frictionless establishment monitor maintains a current location of the customer within the establishment from one or more videos or video feeds.

At 330, the frictionless establishment monitor receives an order from a mobile device operated by the customer.

In an embodiment of 311 and 330, at 331, the frictionless establishment monitor pushes an up-to-date menu to a mobile application (app) of the mobile device using the mobile device identifier from the registered customer profile. The frictionless establishment monitor receives selections from the up-to-date menu as the order based on customer interaction with the app.

At 340, the frictionless establishment monitor places the order with service preparation staff.

At 350, the frictionless establishment monitor monitors the order preparation of the order by the service preparation staff from the one or more videos or video feeds.

At 360, the frictionless establishment monitor notifies a service staff member to deliver the order to the current location of the customer within the establishment when 350 indicates that the order is prepared and ready for pickup and delivery to the customer.

In an embodiment of 331 and 360, at 361, the frictionless establishment monitor sends a message to a service staff member device operated by the service staff member indicating pickup of ordered items for the order are ready for pickup, the name of the customer, the image of the customer, and the current and updated location of the customer within the establishment.

In an embodiment, at 370, the frictionless establishment monitor generates a service request to the service preparation staff or the service staff member based on an action, a behavior, or a gesture made by the customer and detected from the one or more videos or video feeds.

In an embodiment, at 380, the frictionless establishment monitor automatically processes a payment for the order when the customer is detected as exiting the establishment from the one or more videos or video feeds.

In an embodiment, at 390, the frictionless establishment monitor raises an alert to an automated system or a designated resource based on detecting from the one or more videos or video feeds a prohibited action or a prohibited action by one or more of the service preparation staff, the service staff member, or the customer.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying a patron within an establishment from a video;
authenticating the patron to an identity that is linked to a payment method;
tracking the patron to a location within the establishment from the video;
generating a service request for the patron based on at least one action, behavior, or gesture detected from the patron in the video;
monitoring a service item being prepared for the service request from the video;
dispatching a service staff member to deliver the service item to the patron at the location when the monitoring indicates the service item is ready for pickup by the service staff member; and
processing a payment for the service item using the payment method when the patron is detected exiting the establishment from the video.

2. The method of claim 1 further comprising, monitoring the patron, the service staff member, and one or more service preparation staff members within the video for prohibited behaviors or prohibited actions.

3. The method of claim 2 further comprising, capturing service item preparation metrics for the one or more service preparation staff members during preparation of the service item from the video and capturing service item delivery metrics for the service staff member from the video.

4. The method of claim 1, wherein authenticating further includes continuously capturing attributes for the patron from the video and providing the attributes to an authenticator until the authenticator authenticates the patron to the identity from the attributes.

5. The method of claim 1, wherein authenticating further includes receiving an automated check-in message from a mobile device of the patron when the mobile device detects the patron within the establishment and authenticating the patron to the identity based on a mobile device identifier associated with the mobile device.

6. The method of claim 1, wherein authenticating further includes obtaining a voice sample from the patron at the location from a microphone and authenticating the patron to the identity based on the voice sample.

7. The method of claim 1, wherein generating further includes sending a menu for the establishment to a mobile device operated by the patron and receiving the service request from selections of the patron with respect to the menu on the mobile device.

8. The method of claim 7 further comprising, identifying a particular gesture made by the patron within the video indicating that the patron desires a refill of a particular beverage.

9. The method of claim 7 further comprising, identifying a particular gesture made by the patron within the video indicating that the patron desires the service staff member to come to the location to assist the patron, and notifying the service staff member to go the location and assist the patron.

10. The method of claim 1, wherein dispatching further includes identifying the service item being placed in a service staff pickup location by a service staff preparation member based on the monitoring and sending a message to a service staff operated device instructing the service staff member to take the service item to the location.

11. The method of claim 1, wherein dispatching further includes updating the location as the patron moves about the establishment, wherein the location associated with the patron when the service request was made is different from the location associated with patron when the service staff member is dispatched to deliver the service item to the patron.

12. A method, comprising:
authenticating a customer within an establishment to a customer identity from attributes that are captured for the customer;
maintaining a current location of the customer within the establishment from a video;
receiving an order from a mobile device of the customer;
placing the order with service preparation staff;
monitoring order preparation of the order by the service preparation staff from the video; and
notifying a service staff member to deliver the order to the current location of the customer when the monitoring indicates the order is prepared.

13. The method of claim 12 further comprising, generating a service request to the service preparation staff or the service staff member based on an action, a behavior, or a gesture made by the customer and detected from the video.

14. The method of claim 12 further comprising, automatically processing a payment for the order when the customer is detected as exiting the establishment from the video.

15. The method of claim 12 further comprising, raising an alert to an automated system or to a designated resource based on detecting from the video a prohibited action or a prohibited behavior by one or more of the service preparation staff, the service staff member, or the customer.

16. The method of claim 12, wherein authenticating further includes linking the customer identity to a registered customer profile comprising, a mobile device identifier for the mobile device, a loyalty account of the customer, a name of the customer, an image of the customer, and a registered payment method for processing payment of the order.

17. The method of claim 16, wherein receiving further includes pushing an up-to-date version of the menu to a mobile application of the mobile device using the mobile device identifier and receiving selections from the up-to-date version of the menu as the order based on customer interaction with the mobile application.

18. The method of claim 17, wherein notifying further includes sending a message to a service staff member device operated by the service staff member indicating a pickup location of order items for the order, the name of the customer, the image of the customer, and the current location of the customer within the establishment.

19. A system, comprising:
cameras configured to capture videos outside an establishment and inside the establishment;
a server comprising a processor and a non-transitory computer-readable storage medium;
the non-transitory computer-readable storage medium comprising executable instructions;
the executable instructions when executed on the processor from the non-transitory computer-readable storage medium causing the processor to perform operations comprising:
authenticating a customer to a customer identity based on attributes captured within the videos;
tracking locations of the customer within the establishment from the videos;
receiving an order from the customer via a mobile device operated by the customer or via speech of the customer captured by a microphone;
submitting the order for the customer to service preparation staff;
monitoring ordered items associated with the order for completing by the service preparation staff from the videos;
notifying a service staff member when at least one ordered item is completed based on the videos and providing a current location of the customer to the staff member;
monitoring the customer from the videos for an action, a behavior, or a gesture indicating that a service request is needed by the customer;
notifying the service preparation staff or the service staff member of the service request and the current location of the customer based on the service request; and
automatically processing a payment for the order when the customer is detected as exiting the establishment from the videos.

20. The system of claim 19, wherein the executable instructions when executed on the processor from the non-transitory computer-readable storage medium further cause the processor to perform additional operations comprising:
monitoring the service preparation staff, the service staff member, and the customer from the videos for a prohibited action or a prohibited behavior;
sending a message to an external system or a designated resource based on a severity level assigned to the prohibited action or the prohibited behavior.
